(19) United States
(12) Patent Application Publication
(10) Pub. No.: US 2026/0214038 A1
(43) Pub. Date: Jul. 23, 2026

(54) METHOD FOR MONITORING A COMMUNICATION CONNECTION BETWEEN TWO NETWORK NODES THAT ARE DIRECTLY CONNECTED TO ONE ANOTHER

(71) Applicant: Continental Automotive Technologies GmbH, Hannover (DE)

(72) Inventor: Helge Zinner, Regensburg (DE)

(73) Assignee: Continental Automotive Technologies GmbH, Hannover (DE)

(21) Appl. No.: 19/139,073

(22) PCT Filed: Dec. 1, 2023
(86) PCT No.: PCT/DE2023/200242

§ 371 Date: Jun. 13, 2025

(30) Foreign Application Priority Data
Dec. 13, 2022 (DE) 10 2022 213 581.4

(51) Int. Cl. H04L 43/0852; H04L 43/106; H04L 43/16

(52) U.S. Cl. CPC H04L 43/0858; H04L 43/106; H04L 43/16

(57) ABSTRACT

An intervention in a direct connection between two network nodes of a system during operation is identified by repeatedly initiating, cyclically or at irregular intervals, messages of a first type, to which messages there are added or assigned a transmission timestamp in the transmitter and/or a reception timestamp in the receiver. After the timestamp has been set and before the message is transmitted via the physical layer and/or after the message has been received via the physical layer and before the reception timestamp is set, the messages are delayed by a previously ascertained limit value or previously ascertained limit values for the direct connection. It is then checked whether the signal transit time has exceeded a predetermined value, and an exceedance is signaled.

### CROSS-REFERENCE TO RELATED APPLICATIONS

The present application is a National Stage Application under 35 U.S.C. § 371 of International Patent Application No. PCT/DE2023/200242 filed on Dec. 1, 2023, and claims priority from German Patent Application No. 10 2022 213 581.4 filed on Dec. 13, 2022, the disclosures of which are herein incorporated by reference in their entireties.

### TECHNICAL FIELD

The present invention relates to communication networks containing network nodes that are time-synchronized with one another. The invention relates in particular to a method for monitoring an Ethernet-based communication network, for example a communication network in a motor vehicle, and to a network node configured to carry out the method, for example in the form of a control device. The method can be used, inter alia, to monitor for errors in the communication network and/or for changes in the network topology. To this end there is provided monitoring of a direct communication connection between two network nodes in the form of electronic control devices, for example.

### BACKGROUND

In many fields of technology, a large number of control devices or computers communicate with one another via networks. In specific applications, it is necessary to synchronize these network nodes with one another in terms of time, for example in interconnected multimedia systems which are to reproduce media content in a time-synchronized manner, or in systems in which a large number of interconnected sensors transmit sensor data to a processing unit, which evaluates sensor data that match in terms of time and generates therefrom control signals for the system.

One application example for the latter application is semi-automated or highly automated driving, in which sensor signals representing the vehicle environment and vehicle states are evaluated in real time or quasi real time in order to derive therefrom, inter alia, control signals for the safe operation of the vehicle. The processing of sensor signals of a large number of sensors also of different type is also referred to as sensor fusion.

Ethernet technologies are increasingly being used in vehicles too, where they replace older or proprietary data connections and data buses. Ethernet-based communication takes place in accordance with the so-called OSI layer model, in which each layer is allocated specific tasks, which must be performed by the entities (devices and software) of the respective layer for the functioning of the communications. Each entity of a layer provides services, in accordance with the standardized network protocol, which can be used by an entity located above it without that entity having to be concerned with how and by what technical means the entity located below it performs the tasks that are incumbent upon it. Corresponding interfaces are thus defined between the different layers.

FIG. 1 schematically shows the known Ethernet-based communication, which, however, is also used in the present invention, between two network nodes 1, 2, for example in the form of control devices, of a wired communication network 3, which operates in a network protocol in accordance with the OSI layer model having 7 layers I to VII in total. The tasks to be performed by the individual layers are implemented in computing units (not shown separately) of the network nodes 1, 2 and are shown schematically in FIG. 1.

In accordance with the OSI layer model known per se, the layers are referred to as follows:
layer I: physical layer,
layer II: data link layer,
layer III: network layer,
layer IV: transport layer,
layer V: session layer,
layer VI: presentation layer,
layer VII: application layer.

Layers III to VII serve to process the physically transmitted data and to assign them to specific applications, which access the transmitted data via the application layer (layer VII). These layers are of an organizational nature and have nothing to do with the physical transmission of the data or data packets. Because these layers are not affected by the present invention, the content of these layers, which is known to a person skilled in the art, will not be described.

The actual data transmission takes place in layers I and II. Layer I (PHY—physical layer) directly contains the means for activation or deactivation of the physical connection. These include in particular devices and network components such as amplifiers, connectors, sockets for the network cable, repeaters, hubs, transceivers and the like. This layer I thus serves for the physical activation of the transmission channel by suitable electrical, optical, electromagnetic or acoustic signals; in the case of wired Ethernet communication networks, the signals are usually electrical or electromagnetic signals. The network interfaces necessary for physical communication are assigned to each network node and form layer I in accordance with the OSI layer model.

Layer II of the OSI layer model, which is referred to as the data link layer or else link layer, serves to organize and control largely error-free transmission and to control access to the transmission medium. Data flow control between the transmitter and the receiver is also realized here. Logically, the data link layer is frequently divided into a medium access control MAC and a logical link control LLC. The medium access control MAC controls how multiple computers share the physical transmission medium that is jointly used. To this end it uses, inter alia, the so-called MAC addresses of the communication participants, said MAC addresses being assigned as a unique identification to each network node as a participant in the communication network 3. The medium access control MAC is managed by the logical link control LLC, which distributes incoming data in each transmission direction and coordinates access to the higher-level layers of the network control. The tasks of the medium access control MAC and of the logical link control LLC form the so-called data link layer (layer II), in which the different network participants are identifiable in order to organize the network communication in a controlled manner. This logical management is integrated schematically in FIG. 1 between the network nodes 1 and 2 in the line, representing the physical connection, of the communication network 3.

The network nodes 1, 2 as participants in the communication network are thus controlled only in the data link layer (layer II), for example by the unique MAC addresses for identifying the individual network participants, which is necessary for the medium access control. In the physical layer (layer I), a network node 1, 2 has no knowledge of the respectively other network nodes 2, 1 in the communication network 3, but controls only the physical communication at its interface to the communication network 3.

A large number of systems which are communicatively connected to one another via Ethernet connections, inter alia systems in vehicles or systems for the synchronized transmission of audio and video signals, can make particularly high demands on the reliability of the transmission and on the temporal coordination of data packets. High demands are made on the temporal coordination of data packets in particular for safety-critical applications, in vehicles, for example, the transmission of sensor and control information for driver assistance systems or autonomous driving. Even comparatively small changes in the signal transit times can lead to changed system behavior, for example because signals that are to be processed together or that must be present with other signals in a specific, closely matched time frame are no longer present, as a result of the change in the signal transit time, such that they correspond with one another. In the case of changed or unpredictable system behavior, the reliability of the system can no longer be ensured.

The extent to which time-synchronized network nodes are used will increase further in future, inter alia because an ever greater number of control devices transmit sensor data from different sensors, which are combined and evaluated in order to provide safety and convenience functions. A particularly important aspect when fusioning sensor data is the temporal association of the sensor data. Depending on the application, it may be necessary to fusion sensor data that are associated on the basis of millisecond or microsecond accuracy, while a greater interval of time between the detection times may sometimes be admissible for other applications. It is also conceivable for the detection times to have to be associated on the basis of an accuracy in the region of nanoseconds. Apart from the data required for the sensor fusion, however, data that have been captured during monitoring of the operation of the vehicle and are used only for maintenance purposes or for documenting approved and proper operation, for example, may also be subject to stringent requirements for capturing and storing them with correct timing.

The time synchronization of network nodes within an Ethernet network can be effected by means of corresponding protocols, so that there is a globally valid time basis within the network. The time synchronization in Ethernet networks is arranged in the IEEE 802.1AS standard, for example, which uses the Precision Time Protocol (PTP).

PTP defines a master/slave clock hierarchy having a best clock within a network, which is also referred to as the grandmaster clock. The time basis of the remaining network nodes within this network is derived from this best clock, the grandmaster, which is ascertained by means of the Best Master Clock Algorithm (BMCA). Based on the grandmaster, time synchronization messages are broadcast over the network. In addition, PTP defines a mechanism for measuring the signal transit time on a connection, as well as a method for exchanging time information.

For determining the grandmaster clock in accordance with the BMCA, IEEE 802.1AS-capable network nodes transmit cyclically Announce messages with information about their internal clock to immediately connected further network nodes. The information about the internal clocks provides an indication of the accuracy of the respective clock, the reference or time reference thereof and other properties that may be used to determine the best clock in the network. Such an Announce message is illustrated by way of example in FIG. 2 a). A receiver of such an Announce message compares the information received with the features of its own internal clock and any messages already received from another port with information relating to clocks of other network nodes, and accepts a clock in another network node if it has better clock parameters. After a short time, the best clock in the network has been ascertained, which then becomes the grandmaster in the network, and a time synchronization spanning tree has been created. In this process, each port of a network node is assigned one of four port statuses. The port that has a shorter path to the grandmaster than its link partner is assigned the “master port” status. The “slave” status is assigned when no other port at this node has this status yet. Disabled is selected by the port that cannot fully support the PTP protocol. The “passive” status is selected if none of the other three statuses applies.

In a variant of the PTP, the generalized Precision Time Protocol (gPTP), two network nodes each always communicate with one another directly for the purpose of time synchronization, and neither of the two network nodes just forwards a received time synchronization message to a further network node in the network. Instead, the time information is corrected by the network node, before it is forwarded, by the previously ascertained signal transit time on the connection via which it receives time synchronization messages from a directly connected network node, and by the internal processing time, before it prepares and forwards a new time synchronization message with the corrected time information. Network nodes that support gPTP are also referred to as “time-aware systems”.

The signal transit time on a connection between two network nodes can be determined by means of the Sync_Follow_Up mechanism, which is illustrated schematically in FIG. 2 b).

The master ports cyclically transmit Sync and Follow_Up messages to the respectively neighboring link partner, that is to say their slave ports. When the sync message leaves the master port, a timestamp is generated and is immediately transmitted in a subsequent Follow_Up message. This timestamp corresponds to the current time of the grandmaster at the time at which the sync message was sent. The receiver is able to determine the signal transit time of the connection from the difference between the times at which the two messages were received, and the receiver can then set its clock therewith and on the basis of the time of the grandmaster clock, said time being transmitted in the Sync message.

The so-called “peer delay mechanism”, which is shown by way of example in FIG. 2 c), is used to determine the delay between two connected ports independently of time synchronization messages of the grandmaster clock. One port, the initiator, starts measuring the line delay by transmitting a Delay_Request message to the port, directly connected thereto, of a network node, the responder. As late as possible before the message is actually transmitted via the Ethernet transceiver, a transmission timestamp with the time t1 is generated and inserted into the message, so that this transmission timestamp t1 defines in a good approximation the actual time at which the message was transmitted. On arrival of the message, the responder generates a reception timestamp t2. In response, the responder transmits a Delay_Response message to the initiator. In this message it transmits the reception timestamp t2 of the Delay_Request message. If this message leaves the responder, said responder in turn generates a transmission timestamp t3, which is sent out to the initiator in an immediately subsequent Delay_Response_Follow-Up message. When the initiator receives the Delay_Response message, it generates a reception timestamp t4. The initiator can use the four timestamps t1 to t4 to calculate the average transit time on the communication route. Since the transit time on a connection route may vary depending on the direction, Delay_Request messages are sent by both communication partners independently of one another.

These measurements can take place cyclically, i.e. at predefined time intervals of, for example, from 100 ms to several seconds or minutes. Even with a time interval of the order of about one second, the network is not greatly loaded, so that even a measurement at these relatively short time intervals is not a problem for the operation of the network.

It may be expedient to carry out such signal transit time measurements between all the network nodes 1, 2 of the communication network 3 that are in communicative connection with one another, preferably in each case as the direct signal transit time between two network nodes 1, 2.

During the development of or when analyzing interconnected systems, it may be necessary to monitor the data traffic transmitted via the network connections, for example in order to locate errors that occur in the system. In order to be able to monitor the communication between two network nodes that are directly connected to one another without the software of the network nodes having to be specially adapted or changed for that purpose, which could lead to changed system behavior in which the error does not occur or in which different errors occur, a so-called Test Access Point (TAP), or a switch or a bridge, is usually inserted into the network connection between the two devices.

It can be seen from the schematic illustration of the physical connection of the communication network 3 shown in FIG. 3 a), according to the solid arrows, that the physical connection can definitely be separated without the access control (MAC in accordance with the data link layer or layer II), which is illustrated by the broken arrows, having to and being able to detect this. To this end, as illustrated in FIG. 3 b), a tap 4, for example a TAP, is interposed at in each case two physical interfaces PHY, to which tap there can be connected, for example, a network analyzer, which analyzes the data traffic between the two network nodes 1, 2 (not shown in the figure).

Such a TAP 4 is simply looped into the existing line connection, copies the data information or data packets bitwise, without analyzing the content thereof, as the data stream passes through, and outputs the copied data information via a further interface. The physical data stream is simply forwarded unchanged. The network analyzer 4 is thus not in evidence in the communication network 3. In particular, the data link layer (layer II of the OSI layer model) of the network nodes 1 and 2 is not aware of the existence of this network analyzer 4.

However, compared to a direct line connection between the network nodes 1 and 2, the looping of the data stream through the TAP 4 leads to a signal transit time of the signals (data packets) transmitted between the network nodes 1 and 2 being lengthened. This lengthening of the signal transit time can amount to several hundred nanoseconds.

The use of switches or bridges in a connection between two network nodes for intercepting the communication has an even greater influence on the communication compared to a TAP. Even though a switch or a bridge, similarly to a TAP, has no direct address, it causes a long delay, inter alia because the data are possibly stored before they are forwarded, and additionally participates in the layer-2 communication.

As has already been described further above, the insertion of a TAP or switch, or of a bridge, can lead to the signal transit time being lengthened, which reduces the accuracy of the time synchronization or even disrupts or prevents it. In particular in systems in which correct and reliable time synchronization is essential for the functioning of a large number of systems comprising interconnected network nodes, disrupted or failed time synchronization can lead to one or more network nodes subsequently changing from the original operating mode into a different operating mode, for example an error operating mode, and the intended authorized monitoring of the communication of the original operating mode of the network node or of the system cannot take place. Safe operation is thus sometimes no longer ensured, and troubleshooting is also made considerably more difficult. It is easy to see that the disruption of the time synchronization increases with the number of TAPs or switches, or bridges, inserted between two network nodes, unless the signal transit time is redetermined and correspondingly corrected for the forwarding of time synchronization messages.

TAPs or switches, or bridges, can also be inserted into a network connection for reasons other than troubleshooting, for example in order to intercept the communication on the network without authorization and to identify weak points, which can be used to change the system behavior in a targeted manner and without authorization. Such a procedure can be used in particular in systems which are employed identically in a large number. An attacker only needs to gain access to one of the systems and, after analyzing it and locating a weak point, can attack every other one of the systems in a targeted manner.

This harbors a certain risk potential specifically in the case of safety-relevant applications, as are present in the motor vehicle. If, for example, information evaluated by driver assistance systems is transmitted, it is necessary to establish whether this information is being intercepted. Such an interception can pave the way for a targeted attack on the communication system of the motor vehicle, for example by revealing keys or network addresses that are used.

Since it is in principle possible to monitor the participants in the communication network only with knowledge of their addressing, i.e. of their MAC addresses or other unique identification features, in the network, the insertion of a TAP or switch, or of a bridge, forms an opportunity for an attack in an Ethernet-based communication system, said opportunity for an attack not being identifiable in layer II or in higher layers of the OSI layer model.

In a static communication network, for example that of a motor vehicle, in which the network topology does not change unless the network is changed by an authorized or unauthorized intervention, it is possible to detect an intervention by identifying changes in the signal transit time. A possible method which can be used in this connection for measuring the signal transit times between network nodes is the method described with reference to FIG. 2 c).

The use of mean transit times on connections between two network nodes, said mean transit times being ascertained in a system before any intervention, requires these transit times to be stored in each network node for each direct connection with other network nodes. In addition, the measurement of the transit times must be repeated cyclically at not too short intervals in order to be able to identify also interventions of short duration. This can accordingly result cyclically in an increased communication load on the network connection, so that particularly time-critical messages possibly reach their destination with a delay.

### BRIEF SUMMARY

It is therefore desirable to provide a method for monitoring a communication connection between two network nodes, directly connected to one another, of a system, by means of which method an intervention in the direct connection can also be identified in the technical physical layer, on which only the physical data traffic is processed, without having to perform to that end a cyclic measurement of the signal transit time and a comparison with a previously ascertained value of the signal transit time. It is additionally desirable to be able to adapt parameters of the connection between the two network nodes that have been changed by an intervention, such that the operating behavior of the system does not differ from the operating behavior prior to the intervention. It is additionally desirable to provide a network node, in particular a control device of a motor vehicle, which can be connected or is connected to other network nodes and which is configured to carry out one or more embodiments of the monitoring method according to the invention or parts thereof.

According to the invention, parts of this object are achieved by the methods the independent method claims. A further part is achieved by the network node stated in the independent network node claim. Further developments and embodiments of the methods are stated in the respective dependent claims.

According to a first aspect of the invention, in order to identify an intervention in the direct connection between two network nodes (network nodes), it is first necessary to determine a limit value of a parameter of the direct connection between the two network nodes that is exceeded in the event of an intervention in the direct connection and that can be used as a reliable indication of the presence of an intervention. Such a parameter is, for example, the signal transit time on the direct connection, since the signal transit time is increased if a TAP or a switch, or a bridge, is inserted, as is necessary for an active intervention in the direct connection. This parameter cannot be requested from a network node, nor is it available in a database or the like for retrieval. Moreover, the parameter can be different for each link and each link type. In the context of this description, the expression “direct connection” means a direct physical connection between two network nodes, i.e. without interposed other network nodes.

A method according to the invention for determining a limit value of the signal transit time of a direct connection between two network nodes first comprises ascertaining the signal transit time on the direct connection at a time at which there is no intervention in the direct connection between two network nodes, directly connected to one another, of a system. This can be carried out, for example, by means of the peer-delay method known from the IEEE 802.1AS standard, wherein the measurement can be carried out in one direction or in both directions. The signal transit time can, however, also be ascertained by retrieval from a database or a configuration memory if the signal transit time has been determined previously and does not change over time. Other methods for determining the signal transit time are conceivable and known to a person skilled in the art.

In a next step, the transmission of a message of a first type via the direct connection is initiated, to which first type of message there is added or assigned a transmission timestamp at least in the transmitter. In addition, a reception timestamp can be added or assigned to the first type of message in the receiver.

On the basis of the timestamp(s) in the first type of message, the signal transit time on the physical level can be checked. The first type of message can also trigger a response by the receiver, so that it is also possible to check the signal transit time in the transmitter of the message. The first type of message can be a message from the class of the event messages specified in the IEEE 802.1AS standard, for example likewise a peer-delay message.

Before the previously initiated message of the first type provided with the transmission timestamp is transmitted via the physical layer, it is delayed by a first transmission delay value. In addition or alternatively, the message can be delayed by a first reception delay value after it has been received on the physical layer and before the reception timestamp is set. The first reception delay value can be dependent on or independent of the first transmission delay value.

In accordance with the standard IEEE 802.1AS, it is provided at least for some messages from the class of the event messages that, if the signal transit time on the direct connection exceeds a predetermined value, a variable that previously signaled that the signal transit time on the direct connection was not exceeded is changed. The predetermined value is, for example, a value defined in the IEEE 802.1AS standard via the variable meanLinkDelayThresh. The variable is, for example, the flag asCapableAcrossDomains or asCapable from the IEEE 802.1AS standard, said flag being used in the course of the time synchronization of the network nodes of the system and indicating the capability of a network port to carry out the time synchronization in accordance with the standard. Changes of the value of asCapableAcrossDomains or asCapable, which as a Boolean variable can assume the values true or false, are communicated to a state machine in the PHY, said state machine subsequently setting the status of the port in question to reenabledExt or disabledExt.

The status of the port is communicated, inter alia, in the course of the time synchronization, so that all other network nodes are informed of the change within a short time because of the cyclic transmission of time synchronization messages.

Accordingly, the method comprises checking whether the signal transit time has exceeded a predetermined value. This can be carried out, for example, by comparing the transmission time indicated in the transmission timestamp with the synchronized system time of the receiver, by comparing the transmission time with the reception time transmitted back to the transmitter by the receiver in a response message, by evaluating the asCapableAcrossDomains or asCapable flags of the IEEE 802.1AS standard, by evaluating the port statuses, or by other methods known to a person skilled in the art.

If the test reveals that the signal transit time has not exceeded the predetermined value, the transmission of a further message of a first type via the direct connection is initiated, wherein the delay after setting of the timestamp and before the actual transmission on the physical layer is increased relative to the previously set value. It is then again checked whether the signal transit time has exceeded the predetermined value. The initiation and delayed transmission are repeated, in each case with an increased delay relative to the preceding transmission process, until the signal transit time has exceeded the predetermined value. The last delay value is then outputted and/or stored as the ascertained limit value for the direct connection at which the signal transit time has not yet exceeded the predetermined value. If delay values are set separately both on transmission and on receiving, the last delay values are accordingly stored as the ascertained limit values. The storing can be effected locally or in an external database.

The ascertaining of the limit value between the two network nodes that are directly connected to one another can be carried out in both directions.

In one or more embodiments of the method, after the signal transit time has exceeded the predetermined value for the first time, transmission with the previously set delay is repeated for a previously defined number of tests or repetitions. If the signal transit time has exceeded the predetermined value in all the tests or repetitions in succession, the method moves on to the next step. If the signal transit time is below the predetermined value again before the previously defined number of tests or repetitions is reached, this repetition phase is restarted, wherein transmission and checking are carried out with an increased delay relative to the previously set value. A value for the delay which, as a result of very small deviations that occur in normal operation, leads to the signal transit time either exceeding or falling short of the predetermined value, can thus reliably be identified. When the limit value for the signal transit time is later used, such a value that is at the limit can be used in a targeted manner or omitted, according to the application, in particular if the delay can be set only in discrete steps, which have a specific minimum size.

In one or more embodiments of the method, after the signal transit time has exceeded the predetermined value with a set delay once or optionally multiple times, the value or the values for the delay can be reduced again and the test of whether the signal transit time is exceeded can be carried out again. The reduction and testing are optionally repeated until the signal transit time is below the predetermined value. In one or more embodiments of this method, it can be checked in a repetition phase with the previously set delay whether the signal transit time is below the predetermined value in a previously defined number of tests or repetitions in succession, and the repetition phase can optionally be restarted with a delay that is reduced again.

In order not to disrupt the ongoing operation of the system, it is possible in one or more embodiments of the method, after each message, the signal transit time of which has exceeded the predetermined value, to transmit without a delay a message of the first type to which there is added or assigned a transmission timestamp in the transmitter and/or a reception timestamp in the receiver. It is thus possible to reset a mechanism which is optionally present and which brings the system or one or more network nodes into an error operating mode or another mode that is different from the original operating mode only in the case of a previously defined number of tests. In particular the methods for time synchronization in accordance with the IEEE 802.1AS standard can compensate for the failure of up to two successive synchronization messages. Only in the absence of three successive synchronization messages would the time synchronization of the system be disrupted or reinitiated, would network nodes go into an error mode or exhibit other effects which entail a changed operation of the system.

In one or more embodiments of the method, the addition of the delay for the delayed transmission can be carried out, for example, by encrypting at least the messages of the first type on the physical layer, i.e. on the physical connection, after the timestamp has been set and before the data bits, which are then encrypted, are actually transmitted via the communication medium. The MACsec mechanism known from IEEE 802.1AE can be used for this purpose, for example. The MACsec mechanism supports on the one hand a method for securing the integrity of the transmitted data, and on the other hand the encryption of the data. In the former case, an 8 byte long header and a 16 byte long tail are added by the transmitter and are checked by the receiver in order to ensure the integrity of the data. Only these 24 additional bytes effect an increase in the signal transit time. Because the encryption requires at least the storage of a certain number of data bits, this means that a delay that is dependent, inter alia, also on the number of data bits respectively encrypted in a block is obtained before the message is actually transmitted to the receiver. Moreover, depending on the selected encryption method and key, the number of bits or octets of the message to be transmitted can be increased considerably, so that the amount of data to be transmitted, which is increased as a result of the encryption, also leads to an additional delay. Accordingly, in one or more embodiments of the method, different delays can be set by using different encryption parameters. For example, the use of GCM-AES-128 encryption can effect a shorter delay than the use of GCM-AES-256 encryption. If only a short delay is necessary, the method for ensuring integrity can be used without encrypting the data. Alternatively or in addition to the encryption of the messages of the first type, immediately before the message of the first type is transmitted, any other message can be encrypted and/or transmitted with additional bytes in order to ensure integrity. Since in both cases the amount of data to be transmitted is increased and the corresponding processing optionally requires additional time, the transmission of the following message of the first type after the setting of the transmission timestamp in the flow-control buffer of the transmitter is correspondingly delayed. In the same way, the received message of the first type is stored in the reception buffer until the previously transmitted message is decrypted, so that a delay is effected even before the reception timestamp is set by the use of the MACsec mechanism, and the signal transit time visible for the network nodes is lengthened. Since a response to an encrypted message is also encrypted, the signal transit time can be lengthened considerably when the peer-delay method described with reference to FIG. 2 c) is used.

Because the signal transit times in a static communication network, as is present, for example, in a motor vehicle, do not change substantially, apart from relatively small, insignificant deviations, for example due to a usual jitter or temperature-related transit time differences, the ascertainment of the limit value for the signal transit time does not have to be repeated at short intervals. In order to take account of aging of electronic components in the system of network nodes, it is sufficient to repeat the ascertainment of the limit value at longer time intervals.

According to a second aspect of the invention, in a method for identifying an intervention in a direct connection between two network nodes of a system during operation in a first operating mode, messages of the first type are repeatedly initiated cyclically or at irregular intervals, the transmission time, for example a transmission timestamp, being added or assigned to said messages in the transmitter and/or in the case of which the receiver records the reception time, for example by means of a reception timestamp. After the transmission timestamp has been set and before the message is transmitted via the physical layer and/or after the message has been received via the physical layer and before the reception timestamp is set, at least the messages of the first type are delayed by a limit value ascertained in the above-described method or by limit values ascertained in the above-described method for the signal transit time on the direct connection. It is then checked whether the signal transit time has exceeded a predetermined value. If the signal transit time has exceeded the predetermined value, the exceedance is signaled. It thus becomes possible to identify interventions in the direct connection between the two network nodes and to take measures in response. The lengthening of the signal transit time set by the delay is expediently selected such that, on the one hand, the predetermined value of the signal transit time is reliably not exceeded, but even a small additional lengthening of the signal transit time leads to tan exceedance.

The role of transmitting and receiving network node can also change repeatedly in this aspect of the invention since the messages of the first type can be transmitted cyclically and bidirectionally, i.e. in any communication direction between the two network nodes. The monitoring is expediently carried out cyclically, i.e. at predefined or predefinable time intervals, so that changes can reliably be detected.

As soon as an intervention in a direct connection between two network nodes has been detected, the network node carrying out the method can communicate this to the system components in question on a higher communication level in the OSI layer model. Thus, optionally after further testing of the reliability of the intervention, an adjustment can be triggered in order to allow the system to be operated further again without the predetermined value of the signal transit time being exceeded.

In order to be able to identify and ignore cases in which the predetermined value of the signal transit time is exceeded only once at irregular intervals, it can be provided that signaling is carried out only if the predetermined value of the signal transit time is exceeded multiple times. It is thus possible, for example, to intercept temporary overloads of network nodes, which delay slightly the receiving of a signal or the computing operations thereby carried out but do not constitute an intervention in the structure of the network.

According to one or more embodiments of the method according to the second aspect of the invention, the system, or at least one of the network nodes, is transferred into an error operating mode in response to the signaling that the limit value has been exceeded, in which error operating mode safety-relevant functions, for example, are carried out in a particularly reliable manner or are switched off. A network node operated in an error operating mode can notify other network nodes of the system that it is operating in an error operating mode via the network.

Alternatively, the delay at least of the messages of the first type can be reduced to a reduced value at which the signal transit time does not exceed a predetermined value. For determining this reduced value, the method according to the first aspect of the invention can optionally be used.

If the delay is reduced to a value at which the signal transit time does not exceed the predetermined value, it is possible to restore a system behavior that does not differ from the system behavior before it was signaled that the limit value has been exceeded. As a result, a system behavior changed by the authorized insertion of a TAP into a direct connection between two network nodes, for example, can be returned to a state as it was before the TAP was inserted, so that, for example in the case of troubleshooting, no additional errors caused by the insertion of the TAP occur, or an unchanged operating behavior of the system relative to operation before TAPs were inserted is present.

According to a third aspect of the invention, a network node comprises one or more processors, volatile and nonvolatile memories associated therewith, and a physical network interface, which is communicatively connected to the one or more processors and configured to transmit and/or receive communication medium used jointly via one of a plurality of network nodes. The elements of the network node are communicatively connected to one another by means of one or more data lines or data buses. Computer program instructions are stored in the nonvolatile memory and, when they are executed by the at least one processor, configure the network node to carry out one or more embodiments of the method according to the invention.

According to a fourth aspect of the invention, a system, in particular a vehicle system, comprises one or more network nodes each interconnected via a direct connection. According to the invention, at least one of the network nodes is configured to carry out at least one embodiment of the method according to the invention described further above.

A computer program product according to a fifth aspect of the invention contains instructions which, when executed by a computer, cause the latter to carry out one or more embodiments and further developments of the method described above.

The computer program product can be stored on a computer-readable medium or data carrier. The medium or the data carrier can be in a physical embodiment, for example as a hard disk, CD, DVD, flash memory or the like; however, the medium or the data carrier can also comprise a modulated electrical, electromagnetic or optical signal that can be received by a computer by means of an appropriate receiver and can be stored in the memory of the computer.

The above-described methods and the network nodes that carry out the method can advantageously be implemented without changes in already existing hardware and accordingly can be integrated in already existing networks, since the protocols already used do not have to be changed and the function of the network in normal operation, i.e. without unauthorized intervention in at least one direct connection between two network nodes, is not impaired by the signal transit time being exceeded in an unauthorized manner.

Since the integrity of the direct connections is monitored during ongoing operation, the operational reliability of systems, for example of sensor networks and of control devices which control and perform actions on the basis of sensor data, can be increased, for example in vehicles with a high degree of driver assistance or in autonomously driving vehicles. Unauthorized interventions in one or more direct connections between two network nodes can quickly be identified and suitable measures can be taken more quickly in order to restore safe operation or transfer to a safe operating mode.

By means of the method for determining the limit value of the signal transit time according to the first aspect, a signal transit time map of the communication network can be applied, the time reserves of the respective connections between two network nodes being plotted in said signal transit time map. This information cannot normally simply be requested from a network node, either because no request has been implemented in this respect, or the implementation is not disclosed. Nevertheless, with the method according to the invention it is possible to identify, inter alia, connections into which network analyzers or diagnostic devices can be looped. In the case of such an authorized intervention in one or more direct connections between two network nodes, a signal transit time that has been increased by the intervention and is then above a predetermined value can be brought back into a range which lies below the predetermined value by correspondingly reducing the delay at the transmitter and/or at the receiver. Thus, a system behavior that has been changed owing to the intervention can again be brought back into a state comparable to that before the intervention. In contrast to earlier methods, it is not necessary to use a restbus simulation or the like to be able to test network nodes separately in the simulated system context. In a comparable manner, it is possible to establish beforehand whether transmission protocols which cause additional time delays on sending can be used in a system.

The methods according to the invention can also be carried out again without great outlay in the case where network nodes are replaced or the communication lines between network nodes are replaced or repaired, in order to ascertain any changed parameters and continue operation of the system as before, optionally with changed delays on individual connections.

Because of the simple and lean implementation and the use of means that are already present in standards, the method described above and the network nodes that carry out the method can be used independently of the platform and therefore flexibly.

The nature of the monitoring proposed overall according to the invention also helps to save additional complex and/or computation-intensive safety protocols. The load on the communication network as a whole is thus reduced.

Although the invention has been described above in relation to Ethernet-based communication and with a strong focus on the automotive sector, the principle is applicable to all systems in which network nodes that are directly connected to one another use methods of the IEEE 802.1AS standard or methods comparable to those described therein for time synchronization, and in which network nodes can in a targeted manner bring about delays between the setting of a timestamp and the actual transmission on the physical layer by diverse measures.

### BRIEF DESCRIPTION OF THE DRAWINGS

The invention will be explained by way of example hereinbelow with reference to the drawing, from which further advantages, features or possible applications of the invention will also become apparent. Here, all of the features described and/or illustrated in the figures form the subject matter of the present invention individually or in any desired combination, even independently of the combination thereof in the claims, or the back-references therein.

FIG. 1 schematically shows the sequence of communication between two network nodes of an Ethernet-based communication network in accordance with the OSI layer model.

FIGS. 2a, 2b, and 2c show swim-lane diagrams of exemplary messages that are used for time synchronization and the measurement of signal transit times.

FIGS. 3a and 3b schematically show the physical and logical communication paths between two network nodes before and after the interposition of a TAP.

FIG. 4 shows a schematic flow diagram of a method for ascertaining a limit value for the signal transit time of two network nodes that are directly connected to one another.

FIG. 5 shows an exemplary schematic flow diagram of a method for ascertaining a limit value for the signal transit time of two network nodes that are directly connected to one another during ongoing operation of a system in a first operating mode, without operation of the system, or of the network nodes, in the first operating mode being disrupted, during the determination of the upper limit value of the signal transit time, in such a manner that it cannot be corrected or compensated for, or one of the network nodes of the system being transferred into a second operating mode.

FIG. 6 shows an exemplary block diagram of a network node having a microprocessor P and a typical physical Ethernet interface PHY,

FIG. 7 shows a schematic flow diagram of a method according to the invention for monitoring the operation of a system having two or more network nodes that are each directly connected to one another,

FIG. 8 shows a schematic flow diagram of an exemplary application of an aspect of the invention in a system having two or more network nodes that are each directly interconnected to one another, and

FIG. 9 shows an exemplary block diagram of a network node configured to carry out one or more aspects of the method according to the invention.

Identical or similar elements may be referenced using the same reference signs in the figures.

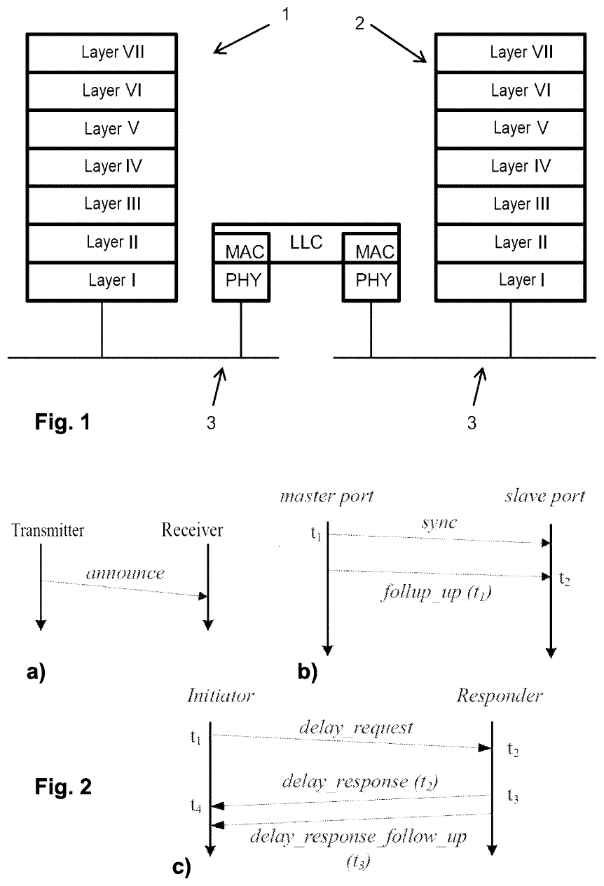

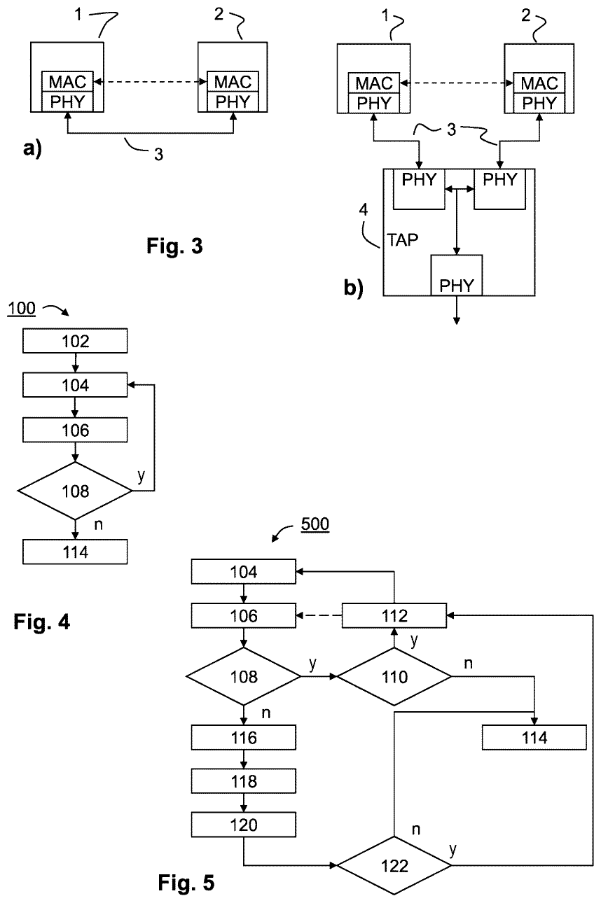

FIGS. 1 to 3 have already been described further above and will therefore not be discussed again hereinbelow.

### DETAILED DESCRIPTION

FIG. 4 shows a schematic flow diagram of a basic method 100 for ascertaining a limit value for the signal transit time of two network nodes that are directly connected to one another. In step 102, the signal transit time in a first operating mode is first measured. To this end, the method described with reference to FIG. 2 c) can be used, for example. The first operating mode is, for example, normal operation of the two network nodes in their system context. The measurement can be carried out repeatedly in succession in order to filter out, by averaging or the like, smaller fluctuations or deviations that can occur in normal operation. In step 104, the transmission of a message of a first type from a first of the two network nodes to the second of the two network nodes is initiated. Before the message is actually transmitted via the communication medium, it is delayed in step 106 by a delay value. In step 108, it is then checked whether, despite the delay, the signal transit time of the message is below a predetermined value, so that the message can be processed by the receiver network node without a change in an operating mode or in an operating parameter of the receiver network node. If this is the case, “yes” branch of step 108, the transmission of further messages of the first type from the first of the two network nodes to the second of the two network nodes is initiated, wherein these further messages of the first type are delayed by a delay value that is increased relative to the respectively preceding delay value of the preceding message. If the check in step 108 reveals that the signal transit time of the message is above a predetermined value owing to the delay, so that the message cannot be processed by the receiver network node without a change in an operating mode or in an operating parameter of the receiver network node, “no” branch of step 108, a limit value for the signal transit time, or at least a limited range within which the limit value lies, is ascertained. The limit value lies in a range, the lower end of which is marked by the sum of the signal transit time first determined in step 102 and the last set delay value at which, despite the delay, the signal transit time of the message is below a predetermined value, so that the message can be processed by the receiver network node without a change in an operating mode or in an operating parameter of the receiver network node. The upper end of the range is marked by the sum of the signal transit time first determined in step 102 and the delay value at which, on account of the delay, the signal transit time of the message is for the first time above a predetermined value, so that the message cannot be processed by the receiver network node without a change in an operating mode or in an operating parameter of the receiver network node. The limit value, or range, ascertained in accordance with the method described above, or a value selected from this range, can then be stored locally and/or outputted in step 114.

FIG. 5 shows an exemplary schematic flow diagram of a method 500 for ascertaining a limit value for the signal transit time of two network nodes that are directly connected to one another during ongoing operation of a system in a first operating mode, without operation of the system, or of the network nodes, in the first operating mode being disrupted, during the determination of the upper limit value of the signal transit time, in such a manner that it cannot be corrected or compensated for, or one of the network nodes of the system being transferred into a second operating mode. The method according to the invention here makes use of the finding that certain messages of the first type do not yet lead to operation being disrupted if a predefined value for the signal transit time is exceeded by not more than a predetermined number of successive messages. Some messages, the signal transit time of which is above the limit value, can increment an error counter, but this is reset again by the next message, the signal transit time of which is below the predefined value. It is thus possible to prevent the operating behavior of the system from being influenced by sporadic errors.

Steps 104, 106 and 108 correspond to those which have already been described with reference to FIG. 4. In step 104, the transmission of a message of a first type from a first of the two network nodes to the second of the two network nodes is initiated. Before the message is actually transmitted via the communication medium, it is delayed in step 106 by a delay value. In step 108, it is then checked whether, despite the delay, the signal transit time of the message is below a predetermined value, so that the message can be processed by the receiver network node without a change in an operating mode or in an operating parameter of the receiver network node.

If this is the case, “yes” branch of step 108, it is checked in step 110 whether it is possible to set a longer delay for messages to be transmitted. If this is possible, “yes” branch of step 110, a longer delay is selected in step 112, and the method is repeated starting with step 104. The setting of a changed delay is indicated by the broken arrow from step 112 to step 106. If it is not possible to set a longer delay for messages to be transmitted, “no” branch of step 110, this longest possible delay is taken as the limit value and is stored and/or outputted in step 114.

If the check in step 108 reveals that the signal transit time is above the predetermined value, “no” branch of step 108, the signal transit time of the direct connection is determined in step 116 for this delay, and the delay is deactivated again in step 118. Then, in step 120, a further message of the first type is transmitted, in order that an error counter that may previously have been incremented by the signal transit time being exceeded is reset again, or the system can compensate for or correct this exceeding of the signal transit time in another way. Then, in step 122, it is checked whether it is possible to set a reduced delay that is below the last set delay but above a delay set before that. If this is not the case, “no” branch of step 122, the delay value that led to the predetermined value being exceeded is taken as the limit value and is stored and/or outputted in step 114.

If the check in step 122 reveals that it is possible to set a reduced delay that is, however, above the last set delay, “yes” branch of step 122, this delay is selected in step 112, and the method is repeated starting with step 104.

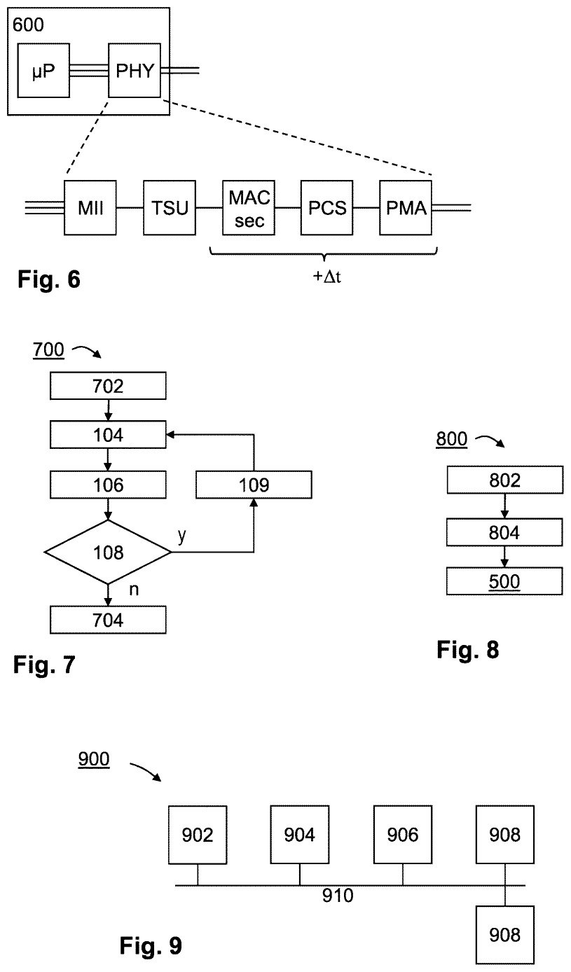

FIG. 6 shows an exemplary block diagram of a network node 600 having a microprocessor P and a typical physical Ethernet interface PHY. The figure shows in particular the point within the PHY at which a transmission timestamp is added or assigned to a message, and the points at which the message can then be delayed. The microprocessor P communicates with the PHY via an interface, which can be implemented in parallel or in series and which generally differs from the Ethernet transmission medium. Accordingly, there is provided on the processor side of the PHY a media-independent interface (MII). The media-independent interface MII receives messages from the MAC of the data link level, layer II of the OSI layer model, for transmission via the transmission medium, or forwards received messages to the MAC. A message to be transmitted, which has been received at the media-independent interface MII and is present virtually in the form of raw data, is subjected to channel coding in a physical coding sublayer PCS before it is actually transmitted. Channel coding serves to protect digital data from transmission errors during transmission via disrupted channels by the addition of redundancy. Channel coding adds redundancy to the data at the input of a transmission channel and decodes the data at its output. When the additional information merely indicates an error and requires the data to be retransmitted, this is referred to as backward error correction. If the redundancy information is sufficient to correct the error, this is forward error correction. Efficient channel coding increases the signal-to-noise ratio while the bit error rate remains unchanged. Depending on the channel coding method, the coding gain can be several dB.

An important property of a channel code is its code rate R=k/n, wherein k denotes the number of symbols at the input of the coder, the information symbols, and n denotes the number of symbols at the output, the code symbols. k information symbols are thus shown over n code symbols. A small rate, i.e. the greater n with identical k, means a higher proportion of code symbols in the transmitting symbols, that is to say a smaller data transmission rate. A channel code with a lower code rate can usually correct more errors than a comparable channel code with a high code rate—that is to say, a trade-off between the data transmission rate and the error correction capability is possible.

Only the channel-coded data are transmitted from an interface PMA adapted to the physical transmission medium into the transmission medium.

Received data are correspondingly processed in the reverse order by the above-mentioned blocks.

If a transmission timestamp is added or assigned to a message before it is transmitted or after it has been received, this can take place in a timestamp unit TSU arranged between the MII and the PCS, so that the timestamps are also included in the channel coding.

The protocols defined in IEEE 802.1AE for the confidential and safe transmission of data, also known by the term MACsec, allow data to be encrypted or decrypted before they are transmitted or after they have been received via the communication medium. Encryption takes place between the setting of the timestamp and before the channel coding, inter alia in order that the timestamp is also protected by the encryption and no insights can be drawn from the analysis of timestamps either.

Starting from the above-described arrangement of the functional blocks and the order of processing of data to be transmitted or of received data that is defined thereby, the settable delay of the messages that is required for the method according to the invention, after the respective timestamp has been set, can thus only be carried out in one or more of the blocks MACsec, PCS or PMA.

Because of the predominantly analog structure of the PMA block, the setting of a delay in this block does not appear possible or appears possible only to an extremely limited extent, which would not be sufficient for the purposes of the invention.

By contrast, the setting of a delay in the PCS block appears entirely possible, for example by the selection of a suitable code rate in the channel coding, by means of which the amount of data transmitted on the communication medium can be varied, so that, solely as a result of the increased amount of data at a small code rate R compared to a large code rate R, a longer transmission time, i.e. an additional delay, can be achieved for a data packet of fixed size.

A particularly suitable block for the setting of a delay after the timestamp has been set and before transmission via the communication medium is the MACsec block. By selecting one of the different encryption methods stipulated in IEEE 802.1AE, if implemented in a PHY of a network node, there is generated from a given amount of data, after the encryption, a respectively different amount of encrypted data, which is always larger. The choice of key, for example the length thereof, can also influence the amount of data added by the encryption. Simply the process of encryption itself requires data to be stored, so that a certain additional delay is obtained. The increased amount of data resulting from the encryption, which must be transmitted via the communication medium at the same speed as unencrypted data, gives rise to a further delay.

For delaying messages of the first type, either the message itself can be encrypted, and/or a message of any type transmitted immediately before the message of the first type can be encrypted. Since the amount of data of a message transmitted before the message of the first type increases as a result of the encryption of said message, messages transmitted subsequently must be correspondingly delayed in the flow-control buffer of the PHY. Thus, by suitably selecting the message to be encrypted, optionally the length thereof, and the encryption method, it is possible to set for parts of the method according to the invention a delay at least of the messages of the first type in a range from several hundred nanoseconds to several microseconds.

The method that is suitable in a particular case, that is to say encryption of a message transmitted immediately before a message of the first type, choice of encryption method, choice of encryption length, choice of length of the message to be encrypted, encryption (also) of the message of the first type and of the key to be respectively used in the process, the length thereof and the encryption method to be used, can depend on the transmission speed of the connection.

FIG. 7 shows a schematic flow diagram of a method 700 according to the invention for monitoring the operation of a system having two or more network nodes that are each directly connected to one another. First of all, a limit value for the signal transit time on a direct connection between two network nodes that is to be monitored is ascertained. To this end, one of the methods described with reference to FIG. 4 or 5 can be used, for example. Alternatively, the limit value can be retrieved from a memory. According to the invention, in step 702 for the sending at least of messages of the first type, the transmission is delayed by a delay value at which the predetermined value for the signal transit time is reliably not yet exceeded. Then, in step 104, the transmission of a message of the first type from a first of the two network nodes to the second of the two network nodes is initiated during operation of the system. Before the message is actually transmitted via the communication medium, it is delayed in step 106 by a delay value. In step 108, it is then checked whether, despite the delay, the signal transit time of the message is below the predetermined value for the signal transit time, so that the message can be processed by the receiver network node without a change in an operating mode or in an operating parameter of the receiver network node. If this is the case, “yes” branch of step 108, the method is repeated starting with step 104 without changing the delay value set in step 702, wherein the repetition can be carried out cyclically or at irregular intervals. The control required for this purpose in each case is indicated by the method step 109 between steps 108 and 104. The control can be of conventional type and use a timer or a (pseudo)random number generator or an external trigger, which reacts to a change in an environmental or system variable or the like.

If the check in step 108 reveals that the signal transit time of the message is above the predetermined value owing to the delay, so that the message cannot be processed by the receiver network node without a change in an operating mode or in an operating parameter of the receiver network node, “no” branch of step 108, an additional delay in the signal transit time must have been introduced into the direct connection between the two network nodes, or a change or disruption of another kind is present. In any case, it is signaled in step 704 that the predetermined value of the signal transit time has been exceeded, whereupon at least the network node that is carrying out the method can initiate further steps or measures.

The monitoring described by the above can thus identify an intervention in a direct connection between two network nodes, said intervention entailing a lengthening of the signal transit time.

If the change in the signal transit time has been caused by an authorized intervention in the system, for example by the temporary insertion of a measuring device via a TAP or a switch, or a bridge, a system behavior as was present before the intervention can be reestablished, for example by the method described with reference to FIG. 8.

FIG. 8 shows a schematic flow diagram of a method 800 of an exemplary application of an aspect of the invention in a system having two or more network nodes that are each directly interconnected to one another. In the exemplary application, it is to be ascertained on which direct connections between respectively two network nodes communication between these network nodes can be recorded and evaluated without the additional lengthening of the signal transit time caused by the necessary insertion of a TAP or switch, or of a bridge, leading to the operation of the system or of the network nodes being disrupted in such a manner that it cannot be corrected or compensated for, or one of the network nodes of the system being transferred into a second operating mode. According to the invention, in step 802 the lengthening of the signal transit time caused by the inserted TAP or switch, or the bridge, is determined. This can be carried out, for example, by suitable measurements, on the basis of details in a data sheet or the like. Then, in step 804, a method is determined by means of which a corresponding delay of messages to be transmitted can be set in the PHY of a network node of the system. It is then verified whether operation of the system in the previously set operating mode is still possible even with the added delay in the connection between two network nodes, or whether none of the network nodes changes to an operating mode that is different to the previously used operating mode. If this is the case, that is to say if operation is possible unchanged, a measuring device, TAP or switch, or a bridge, with a corresponding delay can be looped into this connection. The verification can be carried out by the method described with reference to FIG. 5, for example. With this method, it is thus possible to identify those connections in a system in which a signal transit time lengthened by an intervention can be compensated for without actually having to make the intervention.

If a method for monitoring as has been described with reference to FIG. 7 is carried out in the network nodes of the system, the above-described method can likewise be used. Generally, even in the case of a large number of connections between two network nodes, even a minimal further lengthening of the signal transit time will lead to the predetermined value for the signal transit time being exceeded. However, this can be compensated for by a corresponding reduction in the delay set for normal operation.

FIG. 9 shows an exemplary block diagram of a network device 900 configured to carry out one or more aspects of the method according to the invention. The network device 900 comprises not only a microprocessor 902 but also volatile and nonvolatile memory 904, 906 and one or more communication interfaces 908. The elements of the network device are communicatively connected to one another via one or more data connections or data buses 910. The nonvolatile memory 906 contains computer program instructions which, when they are executed by the microprocessor 902, configure the network device to carry out at least one embodiment of the method according to the invention.

LIST OF REFERENCE SIGNS

| | |
|---|---|
| 1, 2 | network nodes |
| 3 | network/connection |
| 100 | method |
| 102 | measure signal transit time |
| 104 | initiate transmission |
| 106 | delay transmission |
| 108 | pred. value undershot? |
| 109 | repetition control |
| 110 | can a longer delay be set? |
| 112 | select longer/shorter delay |
| 114 | output limit value |
| 116 | determine signal transit time |
| 118 | deactivate delay |
| 120 | transmit message without delay |
| 122 | can a shorter delay be set? |
| 500 | method |
| 600 | network node |
| 700 | method |
| 702 | delay transmission |
| 704 | signal exceedance |
| 800 | method |
| 802 | determine signal transit time |
| 804 | determine delay method |
| 900 | network node |
| 902 | microprocessor |
| 904 | volatile memory |
| 906 | nonvolatile memory |
| 908 | communication interface |
| 910 | data connections/data buses |

1. A method for ascertaining a limit value for the signal transit time on a connection between two network nodes, directly connected to one another, of a system comprising a large number of network nodes that are connected via a network, wherein the method comprises:
a) ascertaining the signal transit time between the network nodes that are directly connected to one another,
wherein the method is characterized by the steps:
b) initiating a message of a first type via the direct connection, to which message there is added or assigned in the transmitter a transmission timestamp and/or in the receiver a reception timestamp,
c) delaying the message, after the transmission timestamp has been set and before the message is transmitted via the physical layer and/or after the message has been received via the physical layer and before the reception timestamp is set, by a first value or in each case by first values,
d) transmitting the message with a delay via the physical layer,
e) checking whether the signal transit time has exceeded a predetermined value,
f1) repeating steps c) to e) with a delay value or delay values which has/have been increased in each case relative to the previously set delay value or relative to the previously set delay values, until the signal transit time has exceeded the predetermined value, and
h) storing and/or outputting the last delay value or the last delay values as the ascertained limit value or the ascertained limit values for the direct connection at which the signal transit time has not yet exceeded the predetermined value.

2. The method as claimed in claim 1, additionally comprising, after the signal transit time has exceeded the predetermined value for the first time in step f1):
f2) repeating steps c) to e) with the previously set delay value or the previously set delay values until the signal transit time has exceeded the predetermined value in a previously defined number of tests or repetitions in succession, wherein, if the signal transit time has fallen below the predetermined value again before the defined number of tests or repetitions has been reached, the method is repeated with step c) and a delay time that is increased again.

3. The method as claimed in claim 1, additionally comprising, after the signal transit time has exceeded the predetermined value in step f1) or has exceeded a previously defined number of tests or repetitions in succession in step f2):
g2) repeating steps c) to e) with a delay value or delay values which has/have been reduced in each case relative to the previously set delay value or relative to the previously set delay values, until the signal transit time no longer exceeds the predetermined value.

4. The method as claimed in claim 3, additionally comprising, after the signal transit time has fallen below the predetermined value for the first time in step g2):
g3) repeating steps c) to e) with the previously set delay value or the previously set delay values until the signal transit time has fallen below the predetermined value in a previously defined number of tests or repetitions in succession, wherein, if the signal transit time has exceeded the predetermined value again before the defined number of tests or repetitions has been reached, the method is repeated with step c) and a delay time that is reduced again.

5. The method as claimed in claim 3, additionally comprising:
g1) initiating and transmitting without a delay a message of a first type via the direct connection, to which message there is added or assigned a transmission timestamp in the transmitter and/or a reception timestamp in the receiver, after each message transmitted with a delay, the signal transit time of which has exceeded the predetermined value.

6. The method as claimed in claim 1, wherein the delayed transmission comprises:
encrypting a message transmitted immediately before a message of the first type, and/or
encrypting at least the first type of messages after the transmission timestamp has been set,
and/or wherein the delayed receiving comprises:
decrypting the message received immediately before a message of the first type, and/or
decrypting at least the first type of messages before the reception timestamp is set.

7. The method as claimed in claim 6, wherein the setting of different delays comprises:
encrypting at least the first type of messages with different encryption parameters.

8. A method for identifying an intervention in a direct connection between two network nodes of a system during operation, comprising:
repeatedly initiating, cyclically or at irregular intervals, messages of the first type, to which there is added or assigned a transmission timestamp in the transmitter and/or a reception timestamp in the receiver,
delaying at least the first type of messages, after the transmission timestamp has been set and before the message is transmitted via the physical layer and/or after the message has been received via the physical layer and before the reception timestamp is set, by an ascertained limit value or by ascertained limit values for the direct connection, wherein the ascertained limit value or the ascertained limit values are ascertained by:
b) initiating a message of a first type via the direct connection, to which message there is added or assigned in the transmitter a transmission timestamp and/or in the receiver a reception timestamp,
c) delaying the message, after the transmission timestamp has been set and before the message is transmitted via the physical layer and/or after the message has been received via the physical layer and before the reception timestamp is set, by a first value or in each case by first values,
d) transmitting the message with a delay via the physical layer,
e) checking whether the signal transit time has exceeded a predetermined value,
f1) repeating steps c) to e) with a delay value or delay values which has/have been increased in each case relative to the previously set delay value or relative to the previously set delay values, until the signal transit time has exceeded the predetermined value, and
h) storing and/or outputting the last delay value or the last delay values as the ascertained limit value or the ascertained limit values for the direct connection at which the signal transit time has not yet exceeded the predetermined value,
checking whether the signal transit time has exceeded a predetermined value,
wherein, if the signal transit time has exceeded a predetermined value, the method additionally comprises:
signaling that the limit value has been exceeded.

9. The method as claimed in claim 8, wherein, in response to the signaling, the system, or at least one of the network nodes, is transferred into an error operating mode or the delaying, at least for the first type of messages, is reduced to a value at which the signal transit time does not exceed a predetermined value.

10. The method as claimed in claim 9, wherein the delaying to a value at which the signal transit time does not exceed a predetermined value comprises ascertaining the limit value again by;
a) ascertaining the signal transit time between the network nodes that are directly connected to one another, further comprising:
b) initiating a message of a first type via the direct connection, to which message there is added or assigned in the transmitter a transmission timestamp and/or in the receiver a reception timestamp,
c) delaying the message, after the transmission timestamp has been set and before the message is transmitted via the physical layer and/or after the message has been received via the physical layer and before the reception timestamp is set, by a first value or in each case by first values,
d) transmitting the message with a delay via the physical layer,
e) checking whether the signal transit time has exceeded a predetermined value,
f1) repeating steps c) to e) with a delay value or delay values which has/have been increased in each case relative to the previously set delay value or relative to the previously set delay values, until the signal transit time has exceeded the predetermined value, and
h) storing and/or outputting the last delay value or the last delay values as the ascertained limit value or the ascertained limit values for the direct connection at which the signal transit time has not yet exceeded the predetermined value.

11. A network node configured to communicate with another network node via a direct connection, having at least one processor, volatile and nonvolatile memory, and a network interface, wherein there are retrievably stored in the nonvolatile memory computer-executable instructions which, when they are executed by the at least one processor, configure the network node to ascertain a limit value for the signal transit time and/or for monitoring the integrity of the communication by performing operations comprising:
a) ascertaining the signal transit time between the network nodes that are directly connected to one another,
wherein the method is characterized by the steps:
b) initiating a message of a first type via the direct connection, to which message there is added or assigned in the transmitter a transmission timestamp and/or in the receiver a reception timestamp,
c) delaying the message, after the transmission timestamp has been set and before the message is transmitted via the physical layer and/or after the message has been received via the physical layer and before the reception timestamp is set, by a first value or in each case by first values,
d) transmitting the message with a delay via the physical layer,
e) checking whether the signal transit time has exceeded a predetermined value,
f1) repeating steps c) to e) with a delay value or delay values which has/have been increased in each case relative to the previously set delay value or relative to the previously set delay values, until the signal transit time has exceeded the predetermined value, and
h) storing and/or outputting the last delay value or the last delay values as the ascertained limit value or the ascertained limit values for the direct connection at which the signal transit time has not yet exceeded the predetermined value.

12. A system, in particular a vehicle system, having two or more network nodes connected to one another in each case via direct connections, wherein at least one of the network nodes is a network node configured to communicate with another network node via a direct connection, having at least one processor, volatile and nonvolatile memory, and a network interface, wherein there are retrievably stored in the nonvolatile memory computer-executable instructions which, when they are executed by the at least one processor, configure the network node to ascertain a limit value for the signal transit time and/or for monitoring the integrity of the communication by performing operations comprising:
a) ascertaining the signal transit time between the network nodes that are directly connected to one another,
wherein the method is characterized by the steps:
b) initiating a message of a first type via the direct connection, to which message there is added or assigned in the transmitter a transmission timestamp and/or in the receiver a reception timestamp,
c) delaying the message, after the transmission timestamp has been set and before the message is transmitted via the physical layer and/or after the message has been received via the physical layer and before the reception timestamp is set, by a first value or in each case by first values,
d) transmitting the message with a delay via the physical layer,
e) checking whether the signal transit time has exceeded a predetermined value,
f1) repeating steps c) to e) with a delay value or delay values which has/have been increased in each case relative to the previously set delay value or relative to the previously set delay values, until the signal transit time has exceeded the predetermined value, and
h) storing and/or outputting the last delay value or the last delay values as the ascertained limit value or the ascertained limit values for the direct connection at which the signal transit time has not yet exceeded the predetermined value.

13. (canceled)

14. A non-transitory computer-readable medium having stored thereon computer-executable instructions that, when executed by a processor, cause performance of operations for ascertaining a limit value for the signal transit time on a connection between two network nodes, directly connected to one another, of a system comprising a large number of network nodes that are connected via a network, wherein the operations comprise:
a) ascertaining the signal transit time between the network nodes that are directly connected to one another,
wherein the method is characterized by the steps:
b) initiating a message of a first type via the direct connection, to which message there is added or assigned in the transmitter a transmission timestamp and/or in the receiver a reception timestamp,
c) delaying the message, after the transmission timestamp has been set and before the message is transmitted via the physical layer and/or after the message has been received via the physical layer and before the reception timestamp is set, by a first value or in each case by first values,
d) transmitting the message with a delay via the physical layer,
e) checking whether the signal transit time has exceeded a predetermined value,
f1) repeating steps c) to e) with a delay value or delay values which has/have been increased in each case relative to the previously set delay value or relative to the previously set delay values, until the signal transit time has exceeded the predetermined value, and
h) storing and/or outputting the last delay value or the last delay values as the ascertained limit value or the ascertained limit values for the direct connection at which the signal transit time has not yet exceeded the predetermined value.
